(19) United States
(12) Patent Application Publication
(10) Pub. No.: US 2008/0148468 A1
(43) Pub. Date: Jun. 26, 2008

(54) Methods and systems for providing chemical and biological protection in turnout gear garments

(76) Inventors: Michael A. Laton, Fayetteville, GA (US); Michael T. Stanhope, Atlanta, GA (US); Charles S. Dunn, Griffin, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/953,660

(22) Filed: Dec. 10, 2007

Related U.S. Application Data
(60) Provisional application No. 60/873,744, filed on Dec. 8, 2006.

(51) Int. Cl. A41D 13/00; A62B 17/00; A41D 3/02; A41D 27/00

(52) U.S. Cl. 2/455; 2/81; 2/85; 2/93; 2/243.1

(57) ABSTRACT

Chemical and biological protective firefighter turnout gear garments are provided. The protective fabric includes at least one sorptive, reactive, or combined sorptive/reactive material capable of providing protection from at least one chemical or biological agent. The sorptive, reactive or sorptive/reactive material preferably can be recharged, regenerated or removed and replaced to allow for increased garment life. Embodiments of the fabric, garment, and methods for making the fabric and/or garment can provide in a protective garment a unique combination of sorptive/reactive capability, flame resistance, water vapor permeability, liquid impermeability, comfort and durability.

This application claims priority to U.S. Provisional Patent Application Ser. No. 60/873,744, entitled “METHODS AND SYSTEMS FOR PROVIDING CHEMICAL AND BIOLOGICAL PROTECTION IN TURNOUT GEAR FABRICS AND GARMENTS,” filed on Dec. 8, 2006, the disclosure of which is incorporated herein by reference in its entirety.

### TECHNICAL FIELD

Provided are chemical and biological protective garments, and in particular turnout gear garments.

### BACKGROUND

Several occupations require individuals to be potentially exposed to extreme heat and/or flames. To avoid being injured while working in such conditions, these individuals typically wear protective garments constructed of special flame resistant materials designed to protect them from both heat and flame. One example of protective garments is worn by firefighters, such as garments commonly referred to in the industry as “turnout gear.” Such turnout gear can include various garments including, for instance, coveralls, trousers, and jackets. These garments usually comprise several layers of material including, for example, an outer shell formed from flame resistant fibers that protects the wearer or user from flames, a moisture barrier that prevents the ingress of liquids into the garment, and one or more thermal barrier layers that insulate the wearer or user from extreme heat. It is desired that, while protecting the wearer against heat and flames, these garments also allow for a high vapor permeability to allow the wearer to expel body heat when exposed to such extreme conditions.

Individuals involved in fighting fires and other emergency rescue professions can be exposed to harmful agents such as industrial chemicals, blood and other bodily fluids, bacteria, and germs. These individuals may also be exposed to toxic chemicals or biological warfare agents. While the garments worn by such individuals are made to be strong and durable, it is not surprising that, given the conditions under which they work, the integrity of the garments can become compromised. Moreover, that the garments are made to be vapor permeable can also render them vulnerable to certain airborne or gaseous chemical and biological agents. It is therefore desirable to provide in such garments a system designed to protect the wearer against chemical and biological agents should such agents penetrate the garment.

Conventional chemical and/or biological protection in garments has been achieved by incorporating into the garment selective semi-permeable membranes as a moisture barrier. Garments so constructed can be relatively stiff and may also lack vapor permeability, thus being uncomfortable to wear. Some semi-permeable membranes may not be relatively durable, or may not be abrasion resistant, thus such garments may need to be replaced frequently. Yet other semi-permeable membranes can over time lose some or all resistance to penetration by certain liquids. Moreover, if the moisture barrier is breached the garment will readily allow harmful chemical or biological agents to pass through to the wearer of the garment.

Chemical and/or biological protection in garments has also been achieved by providing a moisture barrier with a sorptive material embedded within a membrane such as a polytetrafluoroethylene (PTFE) film. Such fabrics and garments can be relatively uncomfortable to wear and have limited sorptive capabilities. In addition, because the sorptive material is embedded within the membrane, the porosity—and thus the vapor permeability—of the membrane, and therefore the moisture barrier, is substantially reduced, resulting in an uncomfortable garment with inadequate vapor permeability properties. Such garments do not conform to “National Fire Protection Association (“NFPA”) 1971 Standard on Protective Ensembles for Structural Fire Fighting and Proximity Fire Fighting” (2007 Edition), a widely accepted—though voluntary—standard which sets minimum compliance requirements for firefighter turnout coats that are procured in North America. Such standards cover vapor permeability, heat, flame, fire and safety performance. The NFPA 1971 standard also provides optional minimum requirements for toxic chemical and/or biological warfare agent protection.

Moreover, for a variety of reasons PTFE moisture barriers are typically the least durable components of a protective ensemble and frequently pinhole (i.e., develop leaks) faster than other garment components. Therefore it is significantly less durable—and garments incorporating it have much shorter useful lives—than other materials formed from, e.g., fabrics.

Accordingly, it is desirable to provide garments having improved chemical and biological protection that conform to the NFPA 1971 standard.

### SUMMARY OF THE INVENTION

Chemical and biological protective garments are provided having incorporated therein at least one sorptive, reactive, or combined sorptive/reactive material capable of providing protection from at least one chemical or biological agent. The sorptive, reactive or sorptive/reactive material preferably can be recharged, regenerated or removed and replaced to allow for increased garment life. Embodiments of the fabric, garment, and methods for making the fabric and/or garment can provide in a protective fabric a unique combination of sorptive/reactive capability, flame resistance, water vapor permeability, liquid impermeability, comfort and durability.

### BRIEF DESCRIPTION OF THE DRAWINGS

The methods and systems described herein can be better understood with reference to the following drawings. The components in the drawings are not necessarily to scale.

FIG. 1 illustrates a partial cut-away view of a protective garment according to one embodiment of the invention.

### DETAILED DESCRIPTION

Systems for providing chemical and biological protection in garments are provided. For purposes of discussion, the systems are described and illustrated for use in a firefighter's turnout coat. However, embodiments of the invention disclosed herein are not limited to such an application. Rather, it is contemplated that the disclosed systems may be incorporated into other types of protective garments.

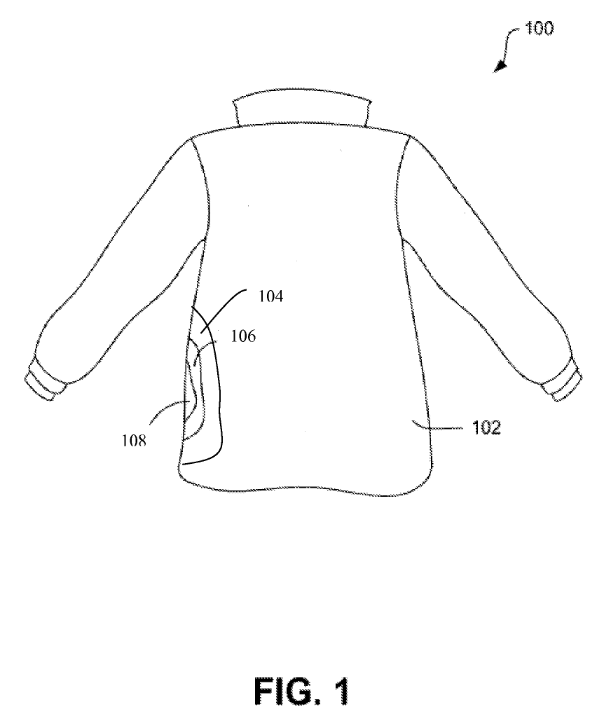

FIG. 1 illustrates a multi-layered protective garment 100 in the form of a conventional firefighter's turnout coat. Protective garment 100 includes an outer shell 102, a semi-permeable moisture barrier layer 104, and a thermal layer 108. In this embodiment, outer shell 102 is the exterior of the garment, farthest from the skin of the wearer, and thermal layer 108 is the interior of the garment, closest to the skin of the wearer.

Outer shell 102 is preferably a fabric made from flame resistant fibers. The outer shell is considered a firefighter's first line of defense, and therefore should not only resist flame, but should also be tough and durable so as not to be torn, abraded, or snagged during normal firefighting activities. Suitable flame-resistant fibers for the outer shell include, but are not limited to, para-aramid fibers (such as KEVLAR™, TECHNORA™, and TWARON™), meta-aramid fibers (such as NOMEX™, CONEX™, and APYEIL™), polybenzimidazole (PBI) fibers, polybenzoxazole (PBO) fibers, melamine fibers (such as BASOFIL™), carbon fibers, pre-oxidized acrylic fibers, polyacrylonitrile (PAN) fibers (such as Panox®), TANLON™, polyamide-imide fibers such as KERMEL™, FR nylon, FR rayon, FR cotton, and blends thereof.

Outer shell 102 can be optionally treated with a water-resistant finish such as a perfluorohydrocarbon to prevent or reduce water absorption from the outside environment in which garment 100 is used. Other finishes can be used with other embodiments, such as a moisture absorbing/wicking finish.

Moisture barrier layer 104 is preferably formed from a liquid impermeable, water vapor-permeable (i.e., semi-permeable) material. The moisture barrier, while also flame resistant, is present to keep liquids from permeating and saturating the garment. Excess moisture entering the gear from the outside would laden the wearer with extra weight and increase the wearer's load, which would increase the possibility of heat stress. Moisture barrier layer 104 can include a FR fabric, such as Nomex®, laminated to a membrane made of a GORE-TEX® brand PTFE-coated fabric such as the RT7100 and Crosstech® products available from Gore™.

Thermal layer 108 is flame resistant and offers the bulk of the thermal protection afforded by the garment. The thermal layer may a needle-punched batt of flame resistant fibers quilted to a lightweight face cloth preferably also made of flame resistant fibers. The thermal layer can be positioned in the garment so that the face cloth faces the firefighter. It may have a wicking finish to wick moisture away from the body of the wearer. Suitable flame-resistant fibers for thermal layer 108 may include, but are not limited to, aramids, flame resistant polynosic rayon, flame resistant cotton, flame resistant polyester, polybenzimidazole, polyvinyl alcohol, polytetrafluoroethylene, flame resistant wool, polyvinyl chloride, polyetheretherketone, polyetherimide, polyethersulfone, polychlal, polyimide, polyamide, polyimide-amide, polyolefin, polybenzoxazole, flame resistant acetone, carbon, modacrylic, acrylic, melamine, glass, and copolymers and mixtures thereof. Preferably, thermal layer 108 is formed from aramid fibers such as the Caldura® and Aralite® line of products available from TenCate™ Southern Mills™.

The garment can include more than one thermal layer, formed from the same materials listed above for thermal layer 108. Second or subsequent thermal layers can be placed anywhere in the garment system, but would typically be located inside outer shell 102, e.g., between outer shell 102 and moisture barrier layer 104 or, more preferably, between moisture barrier layer 104 and thermal layer 108.

Embodiments of this invention incorporate at least one protective component into flame resistant garments, such as the conventional turnout coat discussed above, to protect the garment wearer from harmful chemical and/or biological agents that may penetrate such garments. The protective component includes at least one sorptive material, reactive material, or combined sorptive/reactive material. A preferred sorptive material is activated carbon. A preferred reactive material is titanium dioxide.

Although activated carbon is a preferred sorptive material, the sorptive material can include any material capable of taking up or accumulating—through absorption or adsorption—at least one biological or chemical agent to protect a user from exposure or otherwise reduce the exposure to the biological or chemical agent. In addition, although titanium dioxide is a preferred reactive material, any material or resin system which can react with and cause breakdown—or catalyze the breakdown—of at least one biological or chemical agent to protect a user from exposure, or otherwise reduce the exposure to the biological or chemical agent, can be utilized.

The protective component may assume a variety of forms and may be incorporated into the garment in a variety of ways. In one embodiment, the protective component is a separate protective layer 106 (see FIG. 1) from the other garment layers. More specifically, the protective component may include activated carbon at least partially embedded in or otherwise bonded to a substrate layer. The substrate layer may be a film, such as a flexible, semi-permeable film that may be treated to be flame-resistant. Urethane films are particularly well-suited for use in the protective system. Alternatively, the substrate layer may be a fabric, and preferably, but not necessarily, fabric formed at least in part from flame resistant fibers. The activated carbon can be bonded to such fabric via conventional chemical (e.g., adhesive) or mechanical (e.g., needle-punching) bonding techniques. The activated carbon is typically in the form of beads, fiber, particles, and fabric, but can be any other suitable form. An example of a suitable activated carbon is provided by TrapTek, LLC of Colorado, United States. An example of a suitable titanium dioxide is provided by E. I. du Pont de Nemours and Company. Titanium dioxide can be combined with activated carbon and applied as above, or can be incorporated into a reactive resin system.

The protective component 106 may be positioned in a variety of locations within the garment. It may be positioned between the outer shell 102 and moisture barrier layer 104, within the moisture barrier layer 104, between the moisture barrier layer 104 and the thermal layer 108, or within the thermal layer 108 (e.g., between the non-woven and woven layers of the thermal layer 108 or between multiple thermal layers 108).

In other embodiments, the protective component is not a separate layer but rather is bonded to or provided within existing garment layers. For example, a sorptive, reactive or combined sorptive/reactive material can be applied directly onto moisture barrier layer 104, thermal layer 108 or outer shell 102. More specifically, activated carbon or titanium dioxide may be chemically or mechanically bonded to surfaces of the outer shell 102, the moisture barrier layer 104, and/or the thermal layer 108.

Regardless of the medium by which the protective component is provided, the protective component is preferably, but not necessarily, positioned within or between the moisture barrier layer 104 and the thermal layer 108. In one embodiment (shown in FIG. 1), protective component (in the form of protective layer 106) is located between thermal layer 108 and moisture barrier layer 104. The protective component could be located anywhere in the protective garment, however. For example, the protective component could be located between moisture barrier layer 104 and outer shell 102. This is less desirable, however, because the sorptive, reactive or combined sorptive/reactive material will, in use, receive a much higher exposure to heat and chemical or biological agents and will load or react to a much greater extent than if the sorptive, reactive or sorptive/reactive material were located between or within moisture barrier layer 104 and thermal layer 108.

In use, should harmful chemical and biological agents penetrate the garment, the protective component shields the wearer from such agents. The sorptive material (e.g. activated carbon) absorbs and/or adsorbs the agents until the carbon particles are saturated or fully loaded. The reactive material (e.g., titanium dioxide) either reacts with and breaks down the agents or catalyzes the breakdown of the agents.

When utilized as the sorptive material, activated carbon is preferably capable of being recharged, regenerated or easily replaced. That is, the activated carbon can be subjected to a suitable process—such as with known thermal, steam or chemical processes—to remove unwanted chemical or biological substances or materials in the pores of the activated carbon, which can increase the takeup capacity of the activated carbon or otherwise permit the activated carbon to absorb additional chemical or biological substances or materials. A thermal regeneration process is a preferred means for recharging or regenerating the activated carbon.

Thus, it may be desirable that the protective component be removable from the protective garment in order to (1) facilitate recharging/regeneration of the sorptive, reactive or combined sorptive/reactive material or (2) allow replacement of the sorptive, reactive or sorptive/reactive material. By way only of example, if the protective component is provided in the garment as a separate protective layer 106, such layer can be temporarily fixed within the garment (such as via snaps, hook and loop fasteners, and other mechanical retention means) such that it is easily removable/replaceable. Similarly, if the protective component is provided on or within an existing garment layer, such layer may also be similarly temporarily fixed into the garment. The sorptive, reactive or sorptive/reactive material of the protective component can thus be readily removed from the garment for recharging/regeneration or replacement.

Protective garments made in accordance with the methods described above provide unexpectedly superior performance over previous fabrics and garments. While still affording the necessary flame resistance, these garments impart chemical and biological protection to the wearer without detrimentally impacting the vapor permeability (and thus wear comfort) of the garments. Consequently, such garments remain in compliance with the vapor permeability requirements set forth in the NFPA 1971 standard.

While particular embodiments of improved chemical and biological resistant flame resistant protective garments have been disclosed in detail in the foregoing description and drawings for purposes of example, it will be understood by those skilled in the art that variations and modifications thereof can be made without departing from the scope of the disclosure.

We claim:

1. A garment comprising:
an outer layer of fabric comprising flame resistant fibers;
a thermal layer of fabric comprising flame resistant fibers;
a moisture barrier layer comprising a semi-permeable fabric comprising flame resistant fibers and located between the outer layer and the thermal layer; and
a protective component comprising at least one of activated carbon or titanium dioxide.

2. The garment of claim 1, wherein the protective component is located between or within the moisture barrier layer and the thermal layer.

3. The garment of claim 2, wherein the protective component is bonded to the moisture barrier layer.

4. The garment of claim 2, wherein the protective component is bonded to the thermal layer.

5. The garment of claim 2, wherein the protective component is located within the thermal layer.

6. The garment of claim 2, wherein the protective component comprises a layer.

7. The garment of claim 6, wherein the layer comprises activated carbon at least partially embedded in a film.

8. The garment of claim 7, wherein the film comprises urethane.

9. The garment of claim 6, wherein the layer comprises activated carbon bonded to a fabric comprising flame resistant fibers.

10. The garment of claim 1, wherein the protective component is removable from the garment.

11. The garment of claim 1, wherein the garment complies with NFPA 1971.

12. A garment comprising:
an outer layer of fabric comprising flame resistant fibers;
a thermal layer of fabric comprising flame resistant fibers;
a moisture barrier layer comprising a semi-permeable fabric located between the outer layer and the thermal layer;
wherein at least one of activated carbon or titanium dioxide is applied on a surface of at least one of the outer layer, moisture barrier layer, or thermal layer.

13. A method for forming a protective garment, comprising:
a. providing a garment comprising:
(i) an outer layer of fabric comprising flame resistant fibers;
(ii) a thermal layer of fabric comprising flame resistant fibers;
(iii) a moisture barrier layer comprising a semi-permeable fabric comprising flame resistant fibers and located between the outer layer and the thermal layer; and
b. incorporating into the garment a protective component comprising at least one of activated carbon or titanium dioxide.

14. The method of claim 13, wherein the protective component comprises a layer.

15. The method of claim 14, wherein the layer comprises activated carbon bonded to a fabric comprising flame resistant fibers.

16. The method of claim 13, further comprising removing the protective component from the garment.

17. The method of claim 16, further comprising re-incorporating the removed protective component into the garment.

18. The method of claim 16, further comprising incorporating a new protective component into the garment.

19. A method for improving chemical or biological protection in a protective garment with degraded chemical or biological protective properties, comprising:
a. providing a protective garment comprising:
(i) an outer layer of fabric comprising flame resistant fibers;
(ii) a thermal layer of fabric comprising flame resistant fibers;
(iii) a moisture barrier layer comprising a semi-permeable fabric comprising flame resistant fibers and located between the outer layer and the thermal layer; and
(iv) a removable protective component comprising at least one of activated carbon or titanium dioxide, wherein the protective component has degraded chemical or biological protective capabilities;
b. removing the protective component from the garment;
c. regenerating, recharging or replacing the activated carbon or titanium dioxide in the protective component; and
d. incorporating the removable protective component having the regenerated, recharged or replaced activated carbon or titanium dioxide into the garment.

20. The method of claim 19, wherein the removable protective component comprises activated carbon and the activated carbon is regenerated or recharged by application of a thermal regeneration process.
